(19) United States
(12) Patent Application Publication
(10) Pub. No.: US 2014/0070134 A1
(43) Pub. Date: Mar. 13, 2014

(54) HEAT TRANSFER FLUID CONCENTRATE

(71) Applicants: Peter M. Woyciesjes, Woodbury, CT (US); Aleksei V. Gershun, Southbury, CT (US)

(72) Inventors: Peter M. Woyciesjes, Woodbury, CT (US); Aleksei V. Gershun, Southbury, CT (US)

(73) Assignee: PRESTONE PRODUCTS CORPORATION, Danbury, CT (US)

(21) Appl. No.: 13/606,496

(22) Filed: Sep. 7, 2012

(51) Int. Cl. C09K 5/00

(52) U.S. Cl. CPC C09K 5/00
USPC 252/75; 252/73; 252/74; 252/79

(57) ABSTRACT

Disclosed herein is a heat transfer fluid concentrate comprising greater than or equal to 25 weight percent (wt %), based on the total weight of the concentrate, of glycerin, propylene glycol, or a combination of glycerin and propylene glycol, and greater than or equal to 30 wt %, based on the total weight of the concentrate, of a corrosion inhibitor or combination of corrosion inhibitors.

### BACKGROUND

Modern vehicle engines generally require a heat transfer fluid (liquid coolant) to provide long-lasting, year-round protection of their cooling systems. The primary requirements of the heat transfer fluids are that they provide efficient heat transfer to control and maintain engine temperature for efficient fuel economy and lubrication, and prevent engine failures due to freeze-up, boiling-over, or over-heating. There are a variety of types of heat transfer fluids which comprise a significant quantity of solvent or solvents. As the cost of transportation and packaging rises, the advantages of creating a heat transfer fluid closer to the point of use become clear. Difficulties arise however in the wide range of formulations for heat transfer fluids including different concentrations and different freezing point depressants.

There is an ongoing need for a heat transfer fluid concentrate having wide-ranging utility.

### BRIEF DESCRIPTION

This need is met, at least in part, by a heat transfer fluid concentrate comprising greater than or equal to 25 weight percent (wt %), based on the total weight of the concentrate, of glycerin, propylene glycol, or a combination of glycerin and propylene glycol, and greater than or equal to 30 wt %, based on the total weight of the concentrate, of a corrosion inhibitor or combination of corrosion inhibitors. The heat transfer fluid concentrate can be diluted with a freezing point depressant or a combination of a freezing point depressant and water to form a heat transfer fluid. The heat transfer fluid can be used in a heat transfer system.

### DETAILED DESCRIPTION

Disclosed herein is a heat transfer fluid concentrate comprising glycerin, propylene glycol, or a combination of glycerin and propylene glycol. By using glycerin, propylene glycol or a combination of glycerin and propylene glycol the concentrate can be used to make low toxicity heat transfer fluids. Surprisingly, the heat transfer concentrate can be used (diluted) with a range of freezing point depressants without compromising the freezing point performance (compared to using a concentrate made using the same freezing point depressant as the diluent). In one embodiment, the heat transfer fluid concentrate employs glycerin and is free of any glycol.

There is no particular limitation to the corrosion inhibitors for use herein, and the corrosion inhibitors can comprise azoles, colloidal silica, siloxanes, silicates, carboxylates, tall oil fatty acids, borates, nitrates, nitrites, alkali or alkaline earth metal, ammonium or amine salts thereof, molybdates, inorganic phosphate, polyacrylates, magnesium, lithium, calcium, or a combination of two or more of the foregoing inhibitors.

In general, the combined amount of corrosion inhibitors can be about 30 wt. % to about 65 wt. %, specifically about 32 wt. % to about 55 wt. %, more specifically about 35 wt. % to about 45 wt. %, based on the total weight of the heat transfer fluid. The amounts of the individual corrosion inhibitors are determined by the final application and can be determined by one of skill in the art.

Azoles include five-membered heterocyclic compounds having 1 to 4 nitrogen atoms as part of the heterocycle. Exemplary azoles include benzotriazole, tolyltriazole, methyl benzotriazole (e.g., 4-methyl benzotriazole and 5-methyl benzotriazole), butyl benzotriazole, and other alkyl benzotriazoles (e.g., the alkyl group contains from 2 to 20 carbon atoms), mercaptobenzothiazole, thiazole and other substituted thiazoles, imidazole, benzimidazole, and other substituted imidazoles, indazole and substituted indazoles, tetrazole, tetrahydrotolyltriazole, and substituted tetrazoles. Combinations of two or more of the foregoing azoles may also be used and combinations of azoles are included in the term “azole”. In one embodiment, the azole compound comprises benzotriazole, tolyltriazole, mercaptobenzothiazole, or a combination thereof. In one exemplary embodiment, the azole-based corrosion inhibitor is selected from benzotriazole, tolyltriazole, or a combination thereof.

The azoles can be present in concentrate in an amount up to about 10 wt. %, specifically about 0.10 wt. % to about 10 wt. %, more specifically about 0.30 wt. % to about 8 wt. %, based on the total weight of the concentrate.

Colloidal silica comprises any colloidal silica that can be used as a corrosion inhibitor in heat transfer fluids. Non-limiting examples include colloidal silica of an average particle size of about 1 nanometer (nm) to about 200 nm, more specifically from about 1 nm to about 100 nm, and even more specifically from about 1 nm to about 40 nm. The colloidal silica is advantageous as a corrosion inhibitor, and can advantageously improve the heat transfer properties of the heat transfer fluid. While not wishing to be bound by theory, it is believed that the use of silica of a particular average particle size provides improvements in heat transfer efficiency and/or heat capacity by providing a larger surface area for contact with the heat transfer fluid.

Non-limiting examples of colloidal silica include LUDOX from DuPont or Grace Davidson, NYACOL or BINDZIL from Akzo Nobel or Eka Chemicals, SNOWTEX from Nissan Chemical. Other suppliers of colloidal silica include Nalco and the like.

The colloidal silica can be present in the concentrate in an amount of up to about 9000 parts per million by weight (ppm) in equivalent Si concentration, more specifically of about 1000 ppm to about 7000 ppm, and even more specifically about 500 ppm to about 5000 ppm, based on the total weight of the concentrate.

Siloxanes include polysiloxanes and organosilane compounds comprising a silicon-carbon bond. In one embodiment, the polysiloxanes include those having the formula (I):

[(R¹)₃—Si][OSi(R¹)₂]ₓ[OSi(R¹)₃] (I),

wherein R¹ is independently an alkyl group or a C₁₋₂₀₀ polyalkylene oxide copolymer, and x is from 0 to 100. In one exemplary embodiment, R¹ comprises a polyalkylene oxide copolymer comprising C₂₋₆ alkylene oxide units, and more specifically C₂₋₄ alkylene oxide units. Polysiloxanes having a similar general structure but are outside the scope of formula (I), including commercially available polysiloxanes for which the structure is unknown, can also be used.

Non-limiting examples of commercially available polysiloxanes include the SILWET siloxanes from GE Silicones/OSi Specialties, and other similar siloxane-polyether copolymers available from Dow Corning or other suppliers. In one exemplary embodiment, siloxane-based corrosion inhibitors include SILWET L-77, SILWET L-7657, SILWET L-7650, SILWET L-7600, SILWET L-7200, SILWET L-7210, and the like.

Organosilane compounds are those that include a silicon-carbon bond capable of hydrolyzing in the presence of water to form a silanol, that is, a compound comprising silicon hydroxide. Organosilane compounds comprise those of the formula (II):

R²Si(OR³)₃ (II),

wherein R² and R³ are independently a C₁₋₃₀ aliphatic (including cycloaliphatic) group or aromatic group. In one embodiment, R² is selected from C₁₋₂₀ alkyl groups (including cycloalkyl groups), alkoxy groups, and alkylene groups, and can comprise a heteroatom such as N, S, or the like, in the form of functional groups such as amino groups, epoxy groups, or the like, and R³ is independently selected from C₁₋₆ alkyl groups. Organosilane compounds for which the structure is unknown or which is outside the scope of this formula can also be suitable for use as siloxane-based corrosion inhibitors.

Non-limiting examples of commercially available organosilane compounds include the SILQUEST and FORMASIL surfactants from GE Silicones/OSi Specialties, and other suppliers. In an exemplary embodiment, siloxane-based corrosion inhibitors comprise FORMASIL 891, FORMASIL 593, FORMASIL 433, SILQUEST Y-5560 (polyalkyleneoxidealkoxysilane), SILQUEST A-186 (2-(3,4-epoxycyclohexyl)ethyltrimethoxysilane), SILQUEST A-187 (3-glycidoxypropyltrimethoxysilane), or other SILQUEST organosilane compounds available from GE Silicones, Osi Specialties or other suppliers or the like.

Other non-limiting examples of organosilane compounds for use herein include 3-aminopropyltriethoxysilane, N-2-(aminoethyl)-3-aminopropyltrimethoxysilane, octyltriethoxysilane, vinyltriethoxysilane, vinyltrimethoxysilane, methyltriethoxysilane, 3-methacryloxypropyltrimethoxysilane, 3-mercaptopropyltrimethoxysilane, isobutyltrimethoxysilane, phenyltrimethoxysilane, methyltrimethoxysilane, and those organosilane compounds having a structure similar to the foregoing, but varying numbers of carbon atoms.

Corrosion inhibitors for use herein can also include a silicate. The silicates include inorganic silicates and organic silicates. Inorganic silicates can be represented by the empirical formula:

(MO)ₘSiO_{(4-n/2)}(OH)₁

where M is a monovalent cation that forms a glycol or water soluble silicate and is selected from the group consisting of sodium, potassium, lithium, rubidium and tetraorganoammonium cations, “m” has a value of 1 to 4 inclusive, “1” has a value from 0 to 3 inclusive, and “n” has a value from 1 to 4 inclusive, and which is equal to the sum of “m” and “1”. Inorganic silicates for use herein can be obtained from, for example, the Philadelphia Quartz Company, and are sold under the trade name RU SILICATE (sodium silicate, Na₂O:SiO₂=1:2.4) and KASIL 6 (potassium silicate, K₂O:SiO₂=1:2.1).

Organic silicates include silicate esters such as, but not limited to, those having the formula Si(OR⁵)₄ wherein R⁵ is independently selected from the group consisting of C₁₋₃₆ alkyl, aryl, alkoxyalkyl, alkoxyaryl, hydroxyalkoxy, and a combination thereof. Advantageously, a tetraalkylorthosilicate ester with C₁₋₂₀ alkyl groups (e.g., tetramethylorthosilicate, tetraethylorthosilicate, and the like) can be used. The silicate ester can be present in the heat transfer fluid in an amount of up to about 5 wt. %, and advantageously about 0.01 wt. % to about 5 wt. %, based on the total weight of the heat transfer fluid.

Polymers of the silicates, silicones, or siloxanes can also be used as corrosion inhibitors. They include phosphonate-silicate, sulfonate-silicate, carboxylate-silicate and siloxane-silicate copolymers generally used in the art in silicate-containing heat transfer fluids. These copolymers can be pre-formed or can be formed in situ upon combination of a water-soluble silicate and a water-soluble phosphonate, sulfonate, or siloxane in an aqueous solution at ambient temperature. These copolymers are generally referred to as “siloxane-silicate” copolymers in that each contains silicon in addition to the phosphonate, sulfonate, carboxylate, etc., moiety. In one advantageous embodiment, the siloxane-silicate copolymers provide improved brazed metal corrosion inhibition over the use of simple metal silicates, since the siloxane-silicate copolymers substantially inhibit the gelation tendency of water-soluble silicates at a pH of about 7 to about 11.

Other suitable silicones (or siloxane compounds) or siloxane-silicate copolymers which can be utilized herein include, but are not limited to, those described in U.S. Pat. Nos. 3,341,469; 3,337,496; 3,312,622; 3,248,329; 3,198,820; 3,203,969; 4,093,641; 4,287,077; 4,333,843; 4,352,742; 4,354,002; 4,362,644; 4,370,255; 4,629,602; 4,701,277; and 4,772,408; and also in U.S. Patent Publication No. 2006/0017044.

Non-limiting examples of carboxylates for use herein include saturated and unsaturated aliphatic and aromatic mono-, di- and tricarboxylic acids, and salts and isomers thereof, and any combination thereof. Specifically, the carboxylates include C₄₋₂₅ mono-, di-, and tri-carboxylic acids. Non-limiting examples of the foregoing include 2-ethyl hexanoic acid, heptanoic acid, octanoic acid, nonanoic acid, isoheptanoic acid, neodecanoic acid, benzoic acid, p-toluic acid, p-ethyl benzoic acid, t-butylbenzoic acid, hydroxybenzoic acid, methoxy benzoic acid, dodecanedioic, undecanedioic acid and sebacic acid, as well as esters thereof, salts thereof, anhydrides thereof, and combinations thereof.

In one embodiment, the combined corrosion inhibitor comprises an azole and one or more carboxylic acids. The combined corrosion inhibitor may also consist of an azole and one or more carboxylic acids.

In one embodiment, the heat transfer fluid concentrate is free of silicate, borate and amines. The nitrate content can be less than 50 ppm by weight based on the total weight of the heat transfer fluid.

Exemplary inorganic phosphates include phosphoric acid, sodium orthophosphate, potassium orthophosphate, sodium pyrophosphate, potassium pyrophosphate, sodium polyphosphate, potassium polyphosphate, sodium hexametaphosphate, potassium hexametaphosphate, or a combination of two or more of the foregoing inorganic phosphates.

The acrylate based polymer is a water soluble polymer (MW: 200 to 200,000 Daltons). Exemplary acrylate polymers include polyacrylates, acrylate based polymers, copolymers, terpolymers, and quadpolymers, such as acrylate/acrylamide copolymers, polymethacrylates, polymaleic acids or maleic anhydride polymers, maleic acid based polymers, their copolymers and terpolymers, modified acrylamide based polymers, including polyacrylamides, acrylamide based copolymers and terpolymers; in general, water soluble polymers suitable for use include homo-polymers, copolymers, terpolymer and inter-polymers having (1) at least one monomeric unit containing C₃ to C₁₆ monoethylenically unsaturated mono- or dicarboxylic acids or their salts; or (2) at least one monomeric unit containing C₃ to C₁₆ monoethylenically unsaturated mono- or dicarboxylic acid derivatives such as amides, nitriles, carboxylate esters, acid halides (e.g., chloride), and acid anhydrides, and combination thereof. In some embodiments, the acrylate-based polymer comprises a phosphinopolyacrylate.

The magnesium compound can be an inorganic magnesium compound such as magnesium nitrate, magnesium sulfate, magnesium molybdate, magnesium tungstate, magnesium vanadate, magnesium perchlorate, magnesium hydroxide or a combination thereof. The magnesium compound is soluble in the concentrate. Soluble, as used herein, is defined as dissolving such that no particulate matter is visible to the naked eye. The magnesium compound can also be magnesium salt formed between magnesium ions and an organic acid containing one or more carboxylic acid groups, such as magnesium polyacrylate, magnesium polymaleate, magnesium lactate, magnesium citrate, magnesium tartrate, magnesium gluconate, magnesium glucoheptonate, magnesium glycolate, magnesium glucarate, magnesium succinate, magnesium hydroxysuccinate, magnesium adipate, magnesium oxalate, magnesium malonate, magnesium sulfamate, magnesium formate, magnesium acetate, magnesium propionate, magnesium salt of aliphatic tri-carboxylic acid or aliphatic tetra-carboxylic acid, and combinations of the foregoing magnesium compounds.

The lithium compound can be an inorganic lithium compound such as lithium hydroxide, lithium phosphate, lithium borate, lithium nitrate, lithium perchlorate, lithium sulfate, lithium molybdate, lithium vanadate, lithium tungstate, lithium carbonate or a combination thereof. The lithium compound is soluble in the concentrate. Soluble, as used herein, is defined as dissolving such that no particulate matter is visible to the naked eye. The lithium compound can also be lithium salt formed between lithium ions and an organic acid containing one or more carboxylic acid groups, such as lithium acetate, lithium benzoate, lithium polyacrylate, lithium polymaleate, lithium lactate, lithium citrate, lithium tartrate, lithium gluconate, lithium glucoheptonate, lithium glycolate, lithium glucarate, lithium succinate, lithium hydroxyl succinate, lithium adipate, lithium oxalate, lithium malonate, lithium sulfamate, lithium formate, lithium propionate, lithium salt of aliphatic mono-, di- or tri-carboxylic acid or aromatic mono-, di- or tri-carboxylic acid, and combinations of the foregoing lithium compounds.

The calcium compound can be an inorganic calcium compound such as calcium nitrate, calcium chloride, calcium perchlorate, calcium molybdate, calcium tungstate, calcium vanadate, calcium hydroxide, or a combination thereof. The calcium compound is soluble in the concentrate. Soluble, as used herein, is defined as dissolving such that no particulate matter is visible to the naked eye. The calcium compound can also be calcium salt formed between calcium ions and an organic acid containing one or more carboxylic acid groups, such as calcium polyacrylate, calcium polymaleate, calcium lactate, calcium citrate, calcium tartrate, calcium gluconate, calcium glucoheptonate, calcium glycolate, calcium glucarate, calcium succinate, calcium hydroxysuccinate, calcium adipate, calcium oxalate, calcium malonate, calcium sulfamate, calcium formate, calcium acetate, calcium propionate, calcium salts of aliphatic tri-carboxylic acid or aliphatic tetra-carboxylic acid, and combinations of the foregoing calcium compounds.

The heat transfer fluid concentrate can further comprise a phosphonocarboxylate, a phosphinocarboxylate, antifoaming agent or defoamer, dispersant, scale inhibitor, surfactant, colorant, or a combination of the foregoing.

Phosphonocarboxylates are phosphonated compounds having the general formula

H[CHRCHR]ₙ—PO₃M₂

wherein at least one R group in each unit is a COOM, CH₂OH, sulphono or phosphono group and the other R group which may be the same as, or different from, the first R group, is a hydrogen or a COOM, hydroxyl, phosphono, sulphono, sulphato, C₁₋₇ alkyl, C₁₋₇ alkenyl group or a carboxylate, phosphono, sulphono, sulphato and/or hydroxyl substituted C₁₋₇ alkyl or C₁₋₇ alkenyl group, n is 1 or an integer greater than 1, and each M is hydrogen or an alkali metal ion such as a sodium ion, potassium ion and the like. Furthermore, at least one COOM group will be present in one of the R groups. Preferably, the phosphonocarboxylates are phosphonated oligomers or mixture of phosphonated oligomers of maleic acid, of the formula H[CH(COOM)CH(COOM)]ₙ—PO₃M₂, where n is 1 or an integer greater than 1, and M is a cationic species (e.g., alkali metal cations) such that the compound is water soluble. Exemplary phosphonocarboxylates include phosphonosuccinic acid, 1-phosphono-1,2,3,4-tetracarboxybutane, and 1-phosphono-1,2,3,4,5,6-hexacarboxyhexane. The phosphonocarboxylates can be a mixture of compounds having the preceding formula with differing values for “n”. The mean value of “n” can be 1 to 2, or, more specifically, 1.3 to 1.5. The synthesis of the phosphonocarboxylates is known and described in U.S. Pat. No. 5,606,105. The phosphonocarboxylates are separate and different from the carboxylic acids described above. The carboxylic acid described above consists of carbon, hydrogen and oxygen and are free of non-oxygen heteroatoms.

Phosphinocarboxylates are compounds having the general formula

H[CHR¹CHR¹]ₙP(O₂M)—[CHR²CHR²]ₘH

wherein at least one R¹ group in each unit is a COOM, CH₂OH, sulphono or phosphono group and the other R¹ group which may be the same as, or different from, the first R¹ group, is a hydrogen or a COOM, hydroxyl, phosphono, sulphono, sulphato, C₁₋₇ alkyl, C₁₋₇ alkenyl group or a carboxylate, phosphono, sulphono, sulphato and/or hydroxyl substituted C₁₋₇ alkyl or C₁₋₇ alkenyl group, n is an integer equal to or greater than 1, and each M is hydrogen or an alkali metal ion such as a sodium ion, potassium ion and the like. Similarly, at least one R² group in each unit is a COOM, CH₂OH, sulphono or phosphono group and the other R² group which may be the same as, or different from, the first R² group, is a hydrogen or a COOM, hydroxyl, phosphono, sulphono, sulphato, C₁₋₇ alkyl, C₁₋₇ alkenyl group or a carboxylate, phosphono, sulphono, sulphato and/or hydroxyl substituted C₁₋₇ alkyl or C₁₋₇ alkenyl group, m is an integer equal to or greater than 0. Furthermore, at least one COOM group will be present in one of the R¹ and R² groups. Exemplary phosphinocarboxylates include phosphinicosuccinic acid and water soluble salts, phosphinicobis(succinic acid) and water soluble salts and phosphinicosuccinic acid oligomer and salts as described in U.S. Pat. Nos. 6,572,789 and 5,018,577. The phosphonocarboxylates can be a mixture of compounds having the preceding formula with differing values for “n” and “m”. The phosphinocarboxylates are separate and different from the carboxylic acids described above.

Exemplary surfactants include fatty acid esters, such as sorbitan fatty acid esters, polyalkylene glycols, polyalkylene glycol esters, copolymers of ethylene oxide (EO) and propylene oxide (PO), polyoxyalkylene derivatives of a sorbitan fatty acid ester, and mixtures thereof. The average molecular weight of the non-ionic surfactants can be about 55 to about 300,000, or, more specifically about 110 to about 10,000. Suitable sorbitan fatty acid esters include sorbitan monolaurate (e.g., sold under tradename Span® 20, Arlacel® 20, S-MAZ® 20M1), sorbitan monopalmitate (e.g., Span® 40 or Arlacel® 40), sorbitan monostearate (e.g., Span® 60, Arlacel® 60, or S-MAZ® 60K), sorbitan monooleate (e.g., Span® 80 or Arlacel® 80), sorbitan monosesquioleate (e.g., Span® 83 or Arlacel® 83), sorbitan trioleate (e.g., Span® 85 or Arlacel® 85), sorbitan tridtearate (e.g., S-MAZ® 65K), sorbitan monotallate (e.g., S-MAZ® 90). Suitable polyalkylene glycols include polyethylene glycols, polypropylene glycols, and mixtures thereof. Examples of polyethylene glycols suitable for use include CARBOWAX™ polyethylene glycols and methoxypolyethylene glycols from Dow Chemical Company, (e.g., CARBOWAX PEG 200, 300, 400, 600, 900, 1000, 1450, 3350, 4000 & 8000, etc.) or PLURACOL® polyethylene glycols from BASF Corp. (e.g., Pluracol® E 200, 300, 400, 600, 1000, 2000, 3350, 4000, 6000 and 8000, etc.). Suitable polyalkylene glycol esters include mono- and di-esters of various fatty acids, such as MAPEG® polyethylene glycol esters from BASF (e.g., MAPEG® 200 mL or PEG 200 Monolaurate, MAPEG® 400 DO or PEG 400 Dioleate, MAPEG® 400 MO or PEG 400 Monooleate, and MAPEG® 600 DO or PEG 600 Dioleate, etc.). Suitable copolymers of ethylene oxide (EO) and propylene oxide (PO) include various Pluronic and Pluronic R block copolymer surfactants from BASF, DOWFAX non-ionic surfactants, UCON™ fluids and SYNALOX lubricants from DOW Chemical. Suitable polyoxyalkylene derivatives of a sorbitan fatty acid ester include polyoxyethylene 20 sorbitan monolaurate (e.g., products sold under trademarks TWEEN 20 or T-MAZ 20), polyoxyethylene 4 sorbitan monolaurate (e.g., TWEEN 21), polyoxyethylene 20 sorbitan monopalmitate (e.g., TWEEN 40), polyoxyethylene 20 sorbitant monostearate (e.g., TWEEN 60 or T-MAZ 60K), polyoxyethylene 20 sorbitan monooleate (e.g., TWEEN 80 or T-MAZ 80), polyoxyethylene 20 tristearate (e.g., TWEEN 65 or T-MAZ 65K), polyoxyethylene 5 sorbitan monooleate (e.g., TWEEN 81 or T-MAZ 81), polyoxyethylene 20 sorbitan trioleate (e.g., TWEEN 85 or T-MAZ 85K) and the like.

Exemplary antifoam agents include polydimethylsiloxane emulsion based antifoams. They include PC-5450NF from Performance Chemicals, LLC in Boscawen, N.H.; CNC antifoam XD-55 NF and XD-56 from CNC International in Woonsocket in RI. Other antifoams suitable for use in the instant invention include copolymers of ethylene oxide (EO) and propylene oxide (PO), such as Pluronic L-61 from BASF.

Generally, the optional antifoam agents may comprise a silicone, for example, SAG 10 or similar products available from OSI Specialties, Dow Corning or other suppliers; an ethylene oxide-propylene oxide (EO-PO) block copolymer and a propylene oxide-ethylene oxide-propylene oxide (PO-EP-PO) block copolymer (e.g., Pluronic L61, Pluronic L81, or other Pluronic and Pluronic C products); poly(ethylene oxide) or poly(propylene oxide), e.g., PPG 2000 (i.e., polypropylene oxide with an average molecular weight of 2000); a hydrophobic amorphous silica; a polydiorganosiloxane based product (e.g., products containing polydimethylsiloxane (PDMS), and the like); a fatty acid or fatty acid ester (e.g., stearic acid, and the like); a fatty alcohol, an alkoxylated alcohol and a polyglycol; a polyether polylol acetate, a polyether ethoxylated sorbital hexaoleate, and a poly(ethylene oxide-propylene oxide)monoallyl ether acetate; a wax, a naphtha, kerosene and an aromatic oil; and combinations comprising one or more of the foregoing antifoam agents.

The heat transfer fluid concentrate can be diluted with a freezing point depressant to form a heat transfer fluid. The freezing point depressant can be selected from the group consisting of ethylene glycol, 1,2 propylene glycol, 1,3 propylene glycol, glycerin and combinations thereof. Alternatively, the heat transfer concentrate can be added to an existing heat transfer fluid to alter, tailor or improve the properties of the existing heat transfer fluid. Particularly, this can be done to improve the anti-corrosion properties, lower the freezing point, or both.

The invention is further demonstrated by the following non-limiting examples.

### EXAMPLES

An additive package was combined with two different amounts of glycerin, 1,2-propylene glycol, or 1,3-propylene glycol to form two concentrates with each diluent. Compositions of the concentrates are shown in Table 1. Additionally, a “lx” concentrate was made with ethylene glycol for comparative purposes. Each concentrate was then diluted with a freezing point depressant to form a heat transfer fluid. The heat transfer fluid was then diluted 50 volume percent with deionized water and tested for the freezing point according to ASTM D1177. Data is shown in Table 2. Freezing points are in degrees Celsius.

TABLE 1

| | 1x | 2x | 1x | 2x | 1x | 2x |
|---|---|---|---|---|---|---|
| Chemical | wt % | wt % | wt % | wt % | wt % | wt % |
| 1,2-Propylene glycol | 37.0467 | 54.8534 | | | | |
| 1,3-Propylene glycol | | | 37.0467 | 54.8534 | | |
| Glycerin | | | | | 39.5420 | 56.6429 |
| Neo Decanoic Acid | 9.6107 | 6.8923 | 9.6107 | 6.8923 | 9.5900 | 6.8774 |
| 2-Ethyl Hexanoic Acid | 28.8320 | 20.6767 | 28.8320 | 20.6767 | 28.7700 | 20.6322 |
| NaOH | 9.8902 | 7.0927 | 9.8902 | 7.0927 | 9.8690 | 7.0775 |
| NaTTZ | 2.3651 | 1.6961 | 2.3651 | 1.6961 | 1.1800 | 0.8462 |
| Water | 12.2553 | 8.7888 | 12.2553 | 8.7888 | 11.0490 | 7.9237 |
| Total: | 100.0000 | 100.0000 | 100.0000 | 100.0000 | 100.0000 | 100.0000 |

TABLE 2

| | | | 1,2- | |
|---|---|---|---|---|
| | Ethylene | 1,3- | Propylene | |
| | glycol | Propanediol | glycol | Glycerin |
| Glycerin, 1x | −36.2 | −27.4 | −31.2 | −29.4 |
| Glycerin, 2x | −36.2 | −27.9 | −31.5 | — |
| 1,2-Propylene glycol, | −36.7 | −27.6 | −31.6 | −29.4 |
| 1x | | | | |
| 1,2-Propylene glycol, | −36.0 | −27.7 | — | −29.3 |
| 2x | | | | |
| 1,3-Propylene glycol, | −36.6 | −27.8 | −31.9 | −29.5 |
| 1x | | | | |
| 1,3-Propylene glycol, | −36.5 | — | −31.9 | −29.2 |
| 2x | | | | |
| Ethylene glycol, 1x | −36.6 | — | — | — |

Dilution of the 1× ethylene glycol concentrate with ethylene glycol shows a freezing point of −36.6° C. Surprisingly, dilution of the non-ethylene glycol concentrates with ethylene glycol show surprisingly similar freezing points and dilution of the non-ethylene glycol concentrates with other diluents demonstrate acceptable freezing points (all less than −25° C.).

The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference. The terms “first,” “second,” and the like herein do not denote any order, quantity, or importance, but rather are used to distinguish one element from another. The various embodiments and ranges described herein are combinable to the extent that the description is not contradictory.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

1. A heat transfer fluid concentrate comprising greater than or equal to 25 weight percent (wt %), based on the total weight of the concentrate, of glycerin, propylene glycol, or a combination of glycerin and propylene glycol, and greater than or equal to 30 wt %, based on the total weight of the concentrate, of a corrosion inhibitor or combination of corrosion inhibitors.

2. The heat transfer fluid concentrate of claim 1, wherein the concentrate comprises glycerin and is free of any glycol.

3. The heat transfer fluid concentrate of claim 1, wherein the corrosion inhibitor comprises azoles, colloidal silica, siloxanes, silicates, carboxylates, tall oil fatty acids, borates, nitrates, nitrites, alkali or alkaline earth metal, ammonium or amine salts thereof, molybdates, inorganic phosphate, polyacrylates, magnesium, lithium, calcium, or a combination of two or more of the foregoing inhibitors.

4. The heat transfer fluid concentrate of claim 1, wherein the combined amount of corrosion inhibitors is about 30 wt % to about 65 wt %, based on the total weight of the heat transfer fluid.

5. The heat transfer fluid concentrate of claim 1, wherein the combined amount of corrosion inhibitors is about 32 wt % to about 55 wt %, based on the total weight of the heat transfer fluid.

6. The heat transfer fluid concentrate of claim 1, wherein the combined amount of corrosion inhibitors is about 35 wt % to about 45 wt %, based on the total weight of the heat transfer fluid.

7. The heat transfer fluid concentrate of claim 1, wherein the combined corrosion inhibitor comprises an azole and one or more carboxylic acids.

8. The heat transfer fluid concentrate of claim 1, wherein the combined corrosion inhibitors consists of an azole and one or more carboxylic acids.

9. The heat transfer fluid concentrate of claim 3, wherein the siloxane is a polysiloxane of the formula
[(R¹)₃—Si][OSi(R¹)₂]ₓ[OSi(R¹)₃]
wherein
R¹ is independently an alkyl group or a C₁₋₂₀₀ polyalkylene oxide copolymer, and
x is 1 to 100.

10. The heat transfer fluid concentrate of claim 3, wherein the siloxane is an organosilane of the formula R²Si(OR³)³, wherein R² and R³ are independently a C₁₋₃₀ aliphatic or aromatic group.

11. The heat transfer fluid concentrate of claim 1, further comprising a silicate.

12. The heat transfer fluid concentrate of claim 11, wherein the silicate is of the formula
(MO)ₘSiO_{(4/n-2)}(OH)_{y},
wherein
M is selected from the group consisting of sodium, potassium, lithium, rubidium, and tetraorganoammonium cations;
m is 1 to 4;
n is 1 to 4 and is equal to m+y; and
y is 0 to 3.

13. The heat transfer fluid concentrate of claim 1 further comprising a phosphonocarboxylate, a phosphinocarboxylate, antifoaming agent, defoamer, dispersant, scale inhibitor, surfactant, colorant, or combination thereof.

14. The heat transfer fluid concentrate of claim 13, wherein the phosphonocarboxylate is of the formula
H[CHRCHR]ₙ—PO₃M₂
wherein
at least one R is COOM, CH₂OH, sulphono group, or phosphono group;
the second R is COOM, CH₂OH, sulphono group, phosphono group, H, OH, suphato group, C₁₋₇ alkyl, C₁₋₇ alkenyl, or a carboxylate, phosphono sulphono, sulphato, or hydroxal substituted C₁₋₇ alkenyl or C₁₋₇ alkyl;
n is an integer greater than 1; and
M is H or an alkali metal ion.

15. A method of forming a heat transfer fluid comprising diluting the heat transfer fluid concentrate of claim 1 with a freezing point depressant.

16. The method of claim 15, wherein the freezing point depressant is selected from the group consisting of ethylene glycol; 1,2-propylene glycol; 1,3-propylene glycol; glycerin; and combinations thereof.

17. A method of altering properties of an existing heat transfer fluid comprising adding the heat transfer fluid concentrate of claim 1 to the existing heat transfer fluid.
